(19) United States
(12) Patent Application Publication
(10) Pub. No.: US 2026/0119190 A1
(43) Pub. Date: Apr. 30, 2026

(54) Assigning Keyboard Scan Codes by System Manufacturer

(71) Applicant: Dell Products L.P., Round Rock, TX (US)

(72) Inventors: Jimmy L. Griffith, Pflugerville, TX (US); Kearson M. Mcnulty, Austin, TX (US); Walter Kemp, Georgetown, TX (US)

(73) Assignee: Dell Products L.P., Round Rock, TX (US)

(21) Appl. No.: 18/932,636

(22) Filed: Oct. 31, 2024

(51) Int. Cl. G06F 9/4401

(52) U.S. Cl. CPC G06F 9/4406

(57) ABSTRACT

A method and apparatus for dynamically assigning keyboard scan codes during the manufacturing process of an Information Handling System (IHS). The method involves loading an operating system onto the IHS, utilizing a diagnostic tool to read customer order data, and determining appropriate keyboard scan code settings based on the order data and operating system requirements. The default BIOS scan codes are then modified to align with these settings, enabling the use of a generic keyboard to support multiple configurations and ensuring all keys have defined functions relevant to the operating system and customer preferences.

### BACKGROUND

An Information Handling System (IHS) generally processes, compiles, stores, and/or communicates information or data for business, personal, or other purposes, which allows users to take advantage of that information. Technology and information handling needs and requirements vary between different users and applications. Information handling systems may also vary with respect to what information is handled, how the information is handled, how much information is processed, stored, or communicated, and how quickly and efficiently the information may be processed, stored, or communicated. Variations in information handling systems may be configured for a specific user or specific use, such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Many information handling systems use keyboards to obtain user input. When a user presses a key on the keyboard, an electrical connection is made at the key location. This electrical connection creates a digital signal that is provided to a keyboard controller in the information handling system to indicate that the user has pressed the particular key location. Information handling systems come in a variety of form factors, including desktop form factors that are adapted for workstations and portable form factors that are adapted for mobile use. The information handling system's form factor may affect the associated keyboard, such as the number and arrangement of keys on the keyboard. Different information handling systems often run various operating systems. The type of operating system may determine how keys on the information handling system's keyboard are interpreted.

### SUMMARY

According to one aspect, a method for assigning keyboard scan codes during manufacturing of an Information Handling System (IHS) comprises loading an operating system on the IHS, utilizing a diagnostic tool to read customer order data associated with the IHS, determining, by the diagnostic tool, appropriate keyboard scan code settings based on the customer order data and operating system requirements, and modifying default BIOS scan codes to align with the determined keyboard scan code settings. The modified default BIOS scan codes cause a generic keyboard to provide specific keys required by the operating system.

The specific keys may be one or more of a Windows key and a Copilot key for a Windows operating system. The specific keys may be one or more of a right Control key, a Super key, and a Menu key for a Linux operating system. The specific keys may be one or more of a Command key and an Option key for a macOS operating system.

The modified BIOS default scan codes cause a keyboard with a layout for a first operating system to operate as a keyboard with a layout for a second operating system. The first operating system is a Windows operating system and the second operating system is a Linux operating system, and the modified BIOS default scan codes cause a Copilot key to function as a right Control key.

According to another aspect, a particular key on a keyboard has a first function when used with a first operating system and has a second function when used with a second operating system, and the modified BIOS scan codes cause the particular key to provide the function associated with the operating system loaded on the IHS. The method may further comprise applying a label to the particular key, wherein the label identifies the function associated with the operating system loaded on the IHS.

According to another aspect, a computer system comprises an Information Handling System (IHS) having at least one processor configured to execute an operating system and having a basic input/output system (BIOS) identifying default key scan codes, and a keyboard having a plurality of keys, wherein each of the keys are configured to generate a unique scan code, and the BIOS default key scan codes are configured during manufacture to match scan codes used by the operating system.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram illustrating an embodiment of an Information Handling System for use with audio spatial panning.

FIG. 2 is an example of an older Windows operating system keyboard layout for use with embodiments herein.

FIG. 3 is an example of a newer Windows operating system keyboard layout for use with embodiments herein.

FIG. 4 is an example of a Linux operating system keyboard layout for use with embodiments herein.

FIG. 5 is an example of a macOS operating system keyboard layout for use with embodiments herein.

FIG. 6 is a flowchart illustrating an example process 600 for assigning keyboard scan codes during manufacturing.

FIG. 7A-7D illustrate key numbering and various keyboard layouts for different operating systems and/or user requests.

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

In the following detailed description of embodiments of the disclosure, specific embodiments in which the disclosure may be practiced are described in sufficient detail a person of ordinary skill in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from general scope of the disclosure. The following detailed description is, therefore, not to be taken in a limiting sense, and the scope of the present disclosure is defined by the appended claims and equivalents thereof.

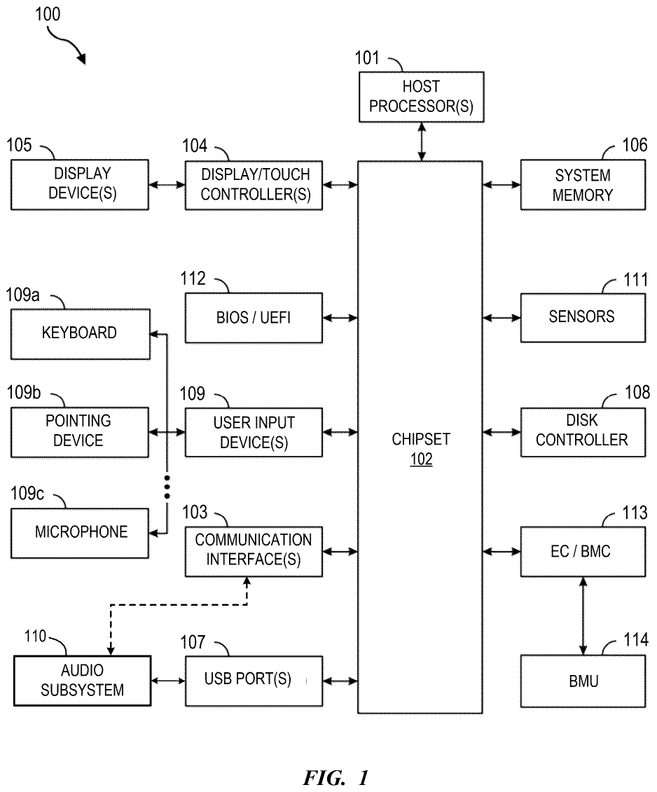

FIG. 1 is a block diagram illustrating an embodiment of an IHS 100. As depicted, IHS 100 includes host processor(s) 101. In various embodiments, IHS 100 may be a single-processor system, or a multi-processor system including two or more processors. Host processor(s) 101 may include any processor capable of executing program instructions, such as an INTEL/AMD x76 processor, or any general-purpose or embedded processor implementing any of a variety of Instruction Set Architectures (ISAs), such as a Complex Instruction Set Computer (CISC) ISA, a Reduced Instruction Set Computer (RISC) ISA (e.g., one or more ARM core(s), or the like).

IHS 100 includes chipset 102 coupled to host processor(s) 101. Chipset 102 may provide host processor(s) 101 with access to resources. In some cases, chipset 102 may utilize a QuickPath Interconnect (QPI) bus to communicate with host processor(s) 101. Chipset 102 may also be coupled to communication interface(s) 103 to enable communications between IHS 100 and various wired and/or wireless networks, such as Ethernet, WiFi (IEEE 802.11), Bluetooth (IEEE 802.15.1), cellular or mobile networks (e.g., Code-Division Multiple Access or “CDMA,” Time-Division Multiple Access or “TDMA,” Long-Term Evolution or “LTE,” etc.), satellite networks, or the like. Communication interface(s) 103 may be used to communicate with peripheral devices (e.g., Bluetooth speakers, microphones, headsets, etc.). Moreover, communication interface(s) 103 may be coupled to chipset 102 via a Peripheral Component Interconnect Express (PCIe) bus, or the like.

Chipset 102 may be coupled to display and/or touchscreen controller(s) 104, which may include one or more Graphics Processor Units (GPUs) on a graphics bus, such as an Accelerated Graphics Port (AGP) or PCIe bus. As shown, display controller(s) 104 provide video or display signals to one or more display device(s) 105. Display device(s) 105 may include Liquid Crystal Display (LCD), Light Emitting Diode (LED), Organic LED (OLED), or other thin film display technologies. Display device(s) 105 may include a plurality of pixels arranged in a matrix, configured to display visual information, such as text, two-dimensional images, video, three-dimensional images, etc. In some cases, display device(s) 105 may be provided as a single continuous display, rather than two discrete displays.

Chipset 102 may provide host processor(s) 101 and/or display controller(s) 104 with access to system memory 106. In various embodiments, system memory 106 may be implemented using any suitable memory technology, such as static RAM (SRAM), dynamic RAM (DRAM) or magnetic disks, or any nonvolatile/Flash-type memory, such as a Solid-State Drive (SSD), Non-Volatile Memory Express (NVMe), or the like.

In certain embodiments, chipset 102 may also provide host processor(s) 101 with access to one or more Universal Serial Bus (USB) ports/controllers 107, to which one or more peripheral devices may be coupled (e.g., integrated or external webcams, microphones, speakers, etc.).

Chipset 102 may further provide host processor(s) 101 with access to a disk controller 108, which may include a disk interface that connects the disc controller 108 to a Hard Disk Drive (HDD), an Optical Disk Drive (ODD), an SSD, and/or a disk emulator. The disk interface may include, for example, an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. The disk emulator may be provide an external interface that permits one or more hard disk drives, solid-state drives, optical drives, or other removable-media drives to be connected to IHS 100. An example of external interface includes a USB interface, an IEEE 1394 (Firewire) interface, a proprietary interface, or a combination thereof.

Chipset 102 may also provide access to one or more user input devices 109, for example, using a super I/O controller or the like. Examples of user input devices 109 include, but are not limited to, a keyboard 109a, pointing device 109b, such as a mouse, trackball, stylus, or active pen, and/or microphone(s) 109c. Other user input devices 109 (not shown) may include a camera, touchpad, totem, etc. Each user input device 109 may include a respective controller (e.g., a touchpad may have its own touchpad controller) that interfaces with chipset 102 through a wired or wireless connection, for example via communication interfaces(s) 103 and/or USB port(s) 107. Other input devices, such as keyboard 109a, may use a keyboard controller in an operating system.

In some cases, chipset 102 may also provide access to one or more output devices, such as an audio subsystem 110, speakers, headsets, video projectors, paper printers, 3D printers, Virtual/Augmented Reality (VR/AR) devices, etc. The output devices may be accessed, for example, via communication interfaces(s) 103 and/or USB port(s) 107. Audio subsystem 110 may include speakers, which comprise any system, device, or apparatus configured to produce sound in response to electrical audio signal input. In some embodiments, a speaker may comprise a dynamic loudspeaker, which employs a lightweight diaphragm mechanically coupled to a rigid frame via a flexible suspension that constrains a voice coil to move axially through a cylindrical magnetic gap such that when an electrical signal is applied to the voice coil, a magnetic field is created by the electric current in the voice coil, making it a variable electromagnet. The coil and the driver's magnetic system interact, generating a mechanical force that causes the coil (and thus, the attached cone) to move back and forth, thereby reproducing sound under the control of the applied electrical signal coming from the amplifier.

In certain embodiments, chipset 102 may further provide an interface for communications with one or more hardware sensors 111. Sensors 111 may be disposed on or within the chassis of IHS 100, or otherwise coupled to IHS 100, and may include, but are not limited to: electric, magnetic, radio, optical (e.g., camera, webcam, etc.), infrared, thermal, force, pressure, acoustic (e.g., microphone), ultrasonic, proximity, position, deformation, bending, direction, movement, velocity, rotation, gyroscope, Inertial Measurement Unit (IMU), and/or acceleration sensor(s).

A Basic Input and Output System/Unified Extensible Firmware Interface (BIOS/UEFI) 112 is coupled to chipset 102. UEFI was designed as a successor to BIOS, and many modern IHSs utilize UEFI in addition to or instead of a BIOS. Accordingly, BIOS/UEFI 112 is intended to also encompass a UEFI component. BIOS/UEFI 112 provides an abstraction layer that allows the OS to interface with certain hardware components that are utilized by IHS 100. Upon booting of IHS 100, host processor(s) 101 may utilize program instructions of BIOS 112 to initialize and test hardware components coupled to IHS 100, and to load a host OS for use by IHS 100. Via the hardware abstraction layer provided by BIOS/UEFI 112, software stored in system memory 106 and executed by host processor(s) 101 can interface with I/O devices coupled to IHS 100.

An Embedded Controller (EC) 113 (sometimes referred to as a Baseboard Management Controller or “BMC”) includes a microcontroller unit or processing core dedicated to handling selected IHS operations not ordinarily handled by host processor(s) 101. Examples of such operations may include, but are not limited to: power sequencing, power management, receiving and processing signals from a keyboard or touchpad, as well as other buttons and switches (e.g., power button, laptop lid switch, etc.), receiving and processing thermal measurements (e.g., performing cooling fan control, throttling CPUs and GPUs, controlling colling fan speeds, and emergency shutdown), controlling indicator Light-Emitting Diodes (LEDs) (e.g., caps lock, scroll lock, num lock, battery, ac, power, wireless LAN, sleep, etc.), managing the battery charger and the battery, enabling remote or Out-of-Band (OOB) management, diagnostics, and remediation over network(s), and the like.

Unlike other devices in IHS 100, EC 113 may be made operational from the very start of each power reset, before other devices are fully running or powered on. As such, EC 113 may be responsible for interfacing with a power adapter to manage the power consumption of IHS 100. These operations may be utilized to determine the power status of IHS 100, such as whether IHS 100 is operating from battery power or is plugged into an AC power source. Firmware instructions utilized by EC 113 may be used to manage other core operations of IHS 100 (e.g., turbo modes, maximum operating clock frequencies of certain components, etc.).

In some cases, EC 113 may implement operations for detecting certain changes to the physical configuration or posture of IHS 100 and managing other devices in different configurations of IHS 100. For instance, when IHS 100 as a 2-in-1 laptop/tablet form factor, EC 113 may receive inputs from a lid position or hinge angle sensor 111, and it may use those inputs to determine: whether the two sides of IHS 100 have been latched together to a closed position or a tablet position, the magnitude of a hinge or lid angle, etc. In response to these changes, the EC may enable or disable certain features of IHS 100 (e.g., front or rear facing camera, etc.).

In some implementations, EC 113 may be installed as a Trusted Execution Environment (TEE) component to the motherboard of IHS 100. Additionally, or alternatively, EC 113 may be further configured to calculate hashes or signatures that uniquely identify individual components of IHS 100. In such scenarios, EC 113 may calculate a hash value based on the configuration of a hardware and/or software component coupled to IHS 100. For instance, EC 113 may calculate a hash value based on all firmware and other code or settings stored in an onboard memory of a hardware component.

In addition, EC 113 may provide an Out-of-Band communication channel that allows an Information Technology Decision Maker (ITDM) or Original Equipment Manufacturer (OEM) to manage IHS 100's various settings and configurations, for example, by issuing OOB commands.

In various embodiments, IHS 100 may be coupled to an external power source through an AC adapter, power brick, or the like. The AC adapter may be removably coupled to a battery charge controller to provide IHS 100 with a source of DC power provided by battery cells of a battery system in the form of a battery pack (e.g., a lithium ion or “Li-ion” battery pack, or a nickel metal hydride or “NiMH” battery pack including one or more rechargeable batteries). Battery Management Unit (BMU) 114 may be coupled to EC 113 and it may include, for example, an Analog Front End (AFE), storage (e.g., non-volatile memory), and a microcontroller. In some cases, BMU 114 may be configured to collect and store information, and to provide that information to other IHS components.

Examples of information collectible by BMU 114 may include, but are not limited to: operating conditions (e.g., battery operating conditions including battery state information such as battery current amplitude and/or current direction, battery voltage, battery charge cycles, battery state of charge, battery state of health, battery temperature, battery usage data such as charging and discharging data; and/or IHS operating conditions such as processor operating speed data, system power management and cooling system settings, state of “system present” pin signal), environmental or contextual information or state (e.g., such as ambient temperature, relative humidity, system geolocation measured by GPS or triangulation, time and date, etc.), events, etc. Examples of events may include, but are not limited to: acceleration or shock events, system transportation events, exposure to elevated temperature for extended time periods, high discharge current rate, combinations of battery voltage, battery current and/or battery temperature (e.g., elevated temperature event at full charge and/or high voltage causes more battery degradation than lower voltage), etc.

In some embodiments, IHS 100 may not include all the components shown in FIG. 1. Furthermore, some components that are represented as separate components in IHS 100 may instead be integrated with other components, such that all or a portion of the operations executed by the illustrated components may instead be executed by the integrated component. For example, in various embodiments described herein, host processor(s) 101 and/or other components shown in FIG. 1 (e.g., chipset 102, display controller(s) 104, communication interface(s) 103, EC 113, etc.) may be replaced by other devices. As such, IHS 100 may assume different form factors including, but not limited to: servers, workstations, desktops, laptops, appliances, video game consoles, tablet computers, smartphones, etc.

Keyboard 109a may be an internal/integral component of IHS 100 or may be an external keyboard 218 that is connected by a wired (e.g., USB or PS/2) or wireless (e.g., Bluetooth) connection to IHS 100. Keyboards have different form factors that vary in size and key type and layout, which may depend upon the type of operating system used by IHS 100 and user preferences. Each key on a keyboard is associated with a specific electrical circuit. When a key is pressed, the circuit completes to generate a unique scan code representing that particular key. The keyboard 109a sends an electronic signal that corresponds to the specific key. A controller inside keyboard 109a detects which key has been pressed by identifying its unique scan code (i.e., a specific number or code assigned to each key). The scan code is a value that identifies the key pressed regardless of the active keyboard layout, as opposed to the character represented by the key. This scan code is transmitted to the keyboard's microcontroller. The microcontroller transmits the scan code to IHS 100 via an interface 109.

The scan code enters the IHS's operating system through an interrupt, which is a signal to the processor to temporarily pause its current task and prioritize handling the scan code. The operating system receives the scan code and uses a keyboard driver to interpret it. The keyboard driver translates the raw scan code into a key code, which represents the actual key pressed in terms that the operating system understands. This translation considers the keyboard layout (e.g., a QWERTY layout) to match the physical key with the intended character, command, or function. Once translated, the key code is passed to an active application. For example, if a user is typing in a text editor, the key code for the “A” key is converted to the character “A” in the application. The application may interpret the input based on its own function capabilities (e.g., pressing “Ctrl+S” in many applications triggers a Save command). In some cases, the operating system may also send signals back to keyboard 218 for tasks such as lighting LEDs (e.g., on a selected Caps Lock key, Num Lock key, etc.).

When the user releases a key, the keyboard sends a separate break code to the IHS to indicate that pressure on the key has been lifted. This process lets the operating system know that the key is no longer being selected, which can stop certain actions such as repeating characters. This chain of events occurs in milliseconds, enabling real-time interaction between user keyboard and computer. The exact steps may vary depending on the type of keyboard (e.g., mechanical, membrane) and the computer's architecture.

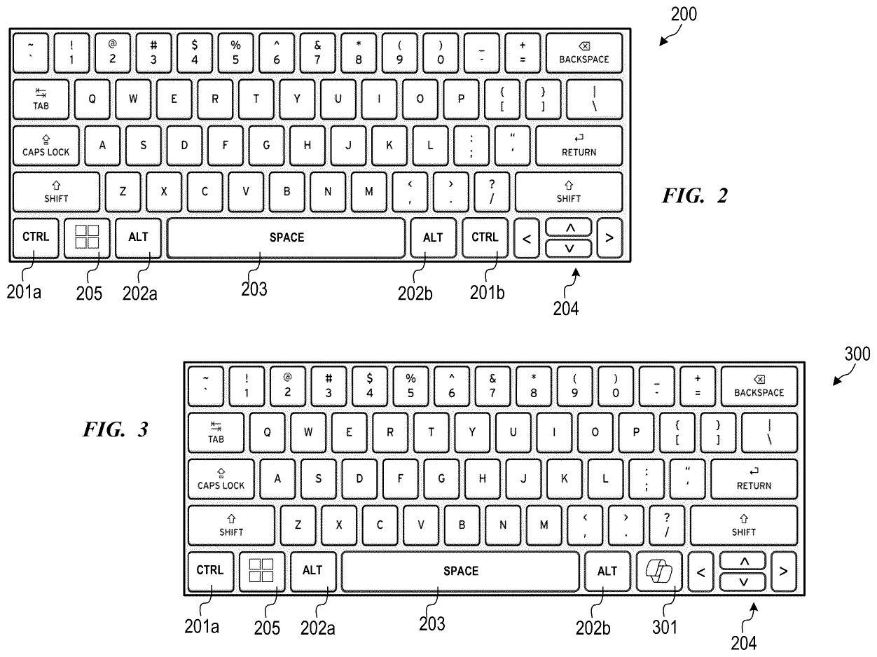

FIGS. 2-5 illustrate example keyboard variations across different operating system. Keyboard layout 200 in FIG. 2 is an example of a Windows operating system keyboard typically used with the Windows operating system. Keyboard layout 200 includes the alphanumeric keys and punctuation keys that are typically found in a typewriter-type layout. Additionally, the bottom row includes command keys, such as left and right control (“CTRL”) keys 201a,b and left and right Alternative (“ALT”) keys 202a,b on either side of space bar 203. Cursor keys (or “Arrow Keys”) 204 allow the user to control a cursor's movement line-by-line vertically or character-by-character horizontally. Keyboard layout 200 also has a Windows key 205, which was introduced in 1994, has the effect of opening the Start menu or may act as a modifier for system shortcuts when used with an IHS running the Windows operating system (e.g., Windows Key+ “E” will open the File Explorer).

Keyboard layout 300 in FIG. 3 is an example of a Windows operating system keyboard introduced in 2024. Layout 300 has the typical alphanumeric, punctuation, cursor control, and the bottom row command keys that are present in layout 200 (FIG. 2). Additionally, keyboard layout 300 adds a new Windows Copilot key 301 that is intended to provide quick access to Microsoft's AI-powered Windows Copilot experience directly from a keyboard button press. In the example layout 300, the Windows Copilot key 301 has replaced the right Control key 201b found in the older layout 200 (FIG. 2). On Windows keyboards, the left and right Control keys 201a and 201b have the same effect as each other (i.e., they are a modifier key that performs special functions when pressed simultaneously with another key). Similarly, the left and right Alternative keys 202a and 202b have the same effect as each other (i.e., a modifier key that changes the function of other keys when pressed simultaneously). Accordingly, changing the functionality of the right Control key 201b (FIG. 2) to a Windows Copilot key 301 (FIG. 3) will not result in the user losing any features.

The Copilot key 301 is a single-purpose feature key added to keyboards made for Microsoft Windows version 11. Copilot key 301 triggers the launch of an interface to a Large Language Model called Copilot. The physical key on the keyboard will typically have a Copilot logo. In one configuration, the Copilot key 301 sends data equivalent to Left Windows+Left Shift+F23, where F23 refers to function key 23. The Copilot assistant can also be launched in Windows version 11 with the key combination Windows+C, which in previous Windows versions launched the Cortana assistant.

Keyboard layout 400 in FIG. 4 is an example of a Linux operating system keyboard. Linux keyboard layouts can vary widely, but many default to a keyboard layout that is similar to Windows. As shown in FIG. 4, the bottom row of keys in layout 400 includes left and right Control keys 401a,b and left and right Alternative keys 402a,b on either side of space bar 403. Linux keyboard layout 400 also includes left and right Super keys 404a,b that are often mapped to open the main menu or perform other system-specific tasks. Linux keyboard layout 400 may include a Menu key 405 with a primary function of launching a context menu.

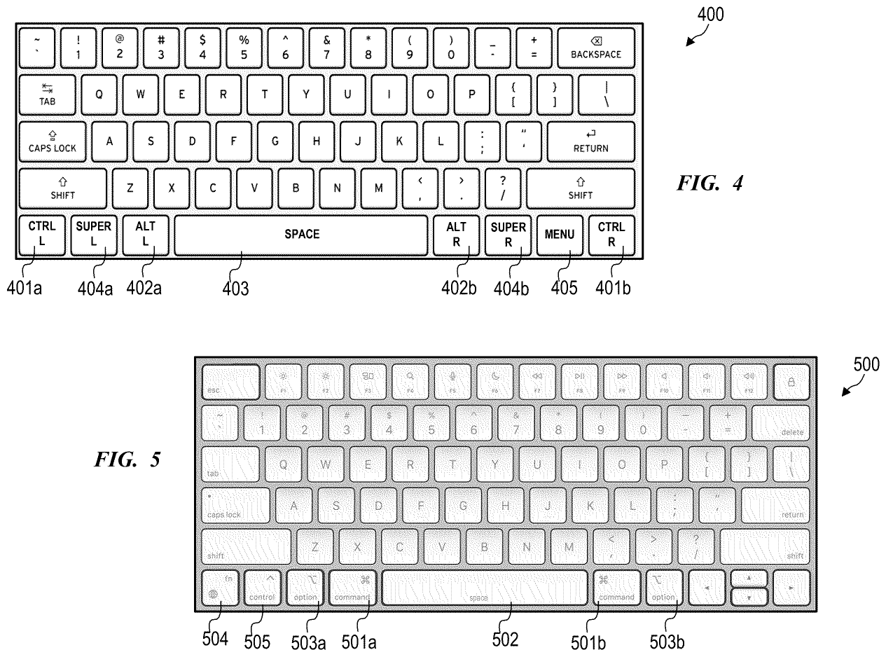

Keyboard layout 500 in FIG. 5 is an example of an Apple Macintosh operating system (“macOS”) keyboard. Mac keyboards 500 have Command keys 501a,b on opposite sides of space bar 502 instead of the Windows key 305. The Command key 501a,b is central to accessing macOS shortcuts. The macOS keyboard layout 500 also includes an Option key 503a,b as another special key, which replaces the Alt key 202a,b in some cases. The Globe key (or Fn key) 504 in keyboard layout 500 is a modifier key for Apple devices that allows users to access functions that do not have their own physical keys. The macOS Control key 505 serves functions related to keyboard shortcuts and contextual menus.

The examples shown in FIGS. 2-5 use the standard QWERTY layout. In other configurations of the alphabet keys are also in use, such as Dvorak and Colemak layouts. For simplicity, the example layouts in FIGS. 2-5 illustrate only the typing and control keys. In other configurations, additional well-known keys may be included in the keyboard layout, such as function keys across a top row or a number pad, a separate arrow key group, or editing keys (e.g., “Insert,” “Delete,” “Home,” “End,” “Page Up,” and “Page Down” keys) to the right of the typing keys.

Generally, a computer workstation will include a keyboard configured for the operating system that is loaded on the associated IHS. Problems can arise when the operating system on the IHS does not match the keyboard. As noted above, different operating systems different have keyboard requirements with specialized keys (e.g., Windows key 205, Copilot key 301, Super keys 404a,b, Menu key 405, Command keys 501a,b, and Option keys 503a,b). These specialized keys are not relevant to all of the different operating system environments that are available. For example, the Linux operating system has no need for the Windows key 205 or the Copilot key 301 from the Windows operating system.

The term “OEM,” as used herein, refers to any manufacturer, vendor, or entity that makes a device or component that is used in another entity's end-product. For example, in various cases, a manufacturer's IHS may include a number of peripheral devices or other components coupled thereto, and those peripheral devices or other components may have been made by another manufacturer. In such cases, the peripheral devices or other components are referred to as OEM devices, the other manufacturer is referred to as an OEM, and the IHS is referred to as the end-product.

When a customer orders a new computer system from an OEM, the customer's order may include several components, such as a particular IHS form (e.g., laptop, desktop, tablet), a particular type of processor(s) to be used in the IHS, an operating system to be loaded on the IHS, a keyboard, and/or other peripherals (monitors, printers, speakers, etc.). Whether the customer is an individual user or a high-volume commercial entity, the computer system manufacturer must ensure that all of the components function together properly. In some cases, a customer may select components that have slight disconnects or mismatches with each other. For example, a customer order may specify an operating system and a keyboard that are not perfectly matched, such as when a Linux operating system is designated along with a keyboard having Windows layout (e.g., layout 300, FIG. 3).

When the Linus operating system is loaded on the IHS, there will be problems if the IHS is then connected to a Copilot keyboard layout 300. The Copilot keyboard layout 300 has keys (i.e., Windows key 205, Copilot key 301) for which the Linux operating system has no defined use. Moreover, the keyboard will be missing keys that the Linux operating system requires for some functionalities (e.g., Super keys 404a,b, Menu key 405, and right Control key 401b). There is a risk of lost productivity and value for the user of an operating system that does not work with the extra keyboard keys and that has a defined use for missing keys.

To address the problem of mismatched operating systems and keyboard layouts, the manufacturer may disable or remap keys for a specific use case and have those changes remain persistent by modifying the BIOS scan codes. This ability will add value to what otherwise would be an unused key on a keyboard. Also, this would allow vendors and manufacturers to fulfill contractual obligations to various vendors (e.g., meet licensing requirements to include certain keys in order to use a particular operating system) while giving customers needed functionality when another operating system is loaded on the machine. Further, this gives customers/users control over how the keyboard interface works based on their own use cases and requirements.

During the manufacturing process (e.g., while loading an operating system and configuring the IHS BIOS), a production manager or other supervising process calls a diagnostics tool that has knowledge of the customer order data. The diagnostic tool decides what the setting should be for each key on the keyboard so that the keyboard is maximally aligned with the needs of the customer order. For example, if the diagnostic tool recognizes that an order includes a Windows keyboard and a Linux operating system, the tool will modify the default BIOS scan codes so that the Copilot key function is replaced with a right Control key function.

This solution would also be used for other operating system or keyboard customization options. A customer may provide an alternative scan code value to be associated with any physical key on a selected keyboard. For example, a customer order may specify a unique operation or function to occur when the CAPS LOCK key is pressed, such as locking the top row of keys to the listed symbols instead of the default numbers without locking the alphabet keys. The alphabet keys would still be capitalized using the SHIFT keys. This change would be effected by modifying how the scan codes are handled in the BIOS, which would cause a permanent change in the system.

As an example, the Copilot key 301 will replace the right Control key 201b on new Windows keyboards. For operating systems that do not use the Copilot key 301, the boot menu may be configured so that the Copilot key 301 does not send its default code, but instead sends the code associated with the right Control key 201b, thereby restoring the functionality lost by the introduction of the Copilot key 301.

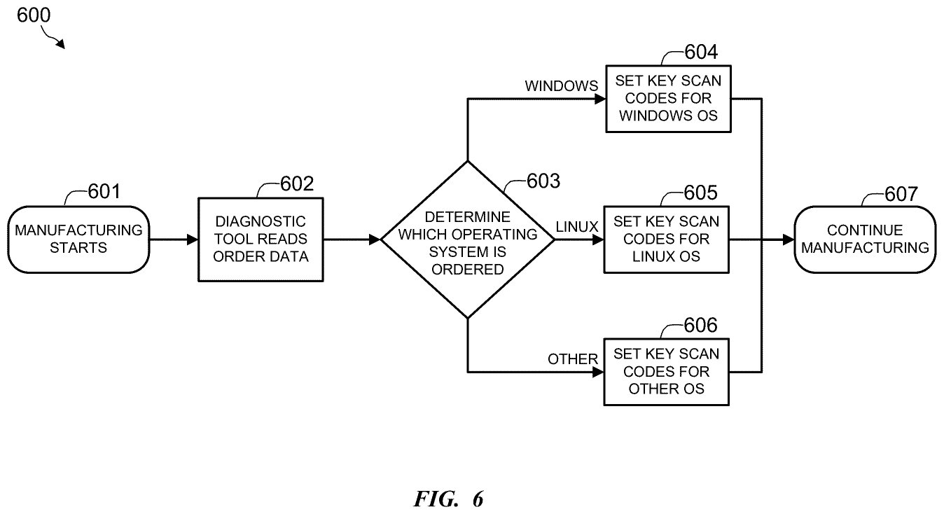

FIG. 6 is a flowchart illustrating an example process 600 for assigning keyboard scan codes during manufacturing. At 601, the manufacturing starts, which may include identifying a customer order, determining what components are ordered, etc. At 602, a diagnostic tool reads the customer order data. The tool may be, for example, a procedure and/or program that includes a script that may be run at time of manufacture that can configure and can verify that IHS components are installed and configured correctly according to customer orders. The script may also create a report of the current IHS device configuration. At 603, the diagnostic tool determines which operating system (OS) is included on the customer order.

The keyboard scan code configurations are set at 604-606 by modifying the default BIOS scan codes to match the operating system. The particular key scan codes that are modified may depend up the type of keyboard selected by the customer (i.e., depending on the keyboard layout included in the order).

This process enables manufacturers to build systems to order and to support multiple keyboard configurations using the same physical keyboard (i.e., a generic keyboard) by modifying with BIOS scan codes to meet the operating system requirements. The keyboard scan codes are changed based on customer order so that a generic keyboard layout will react as the operating system requires. For example, the modified scan codes at 604 for a Windows operating system will allow certain keys to function as a Windows key and/or a Copilot key. Modified scan codes at 605 for a Linux operating system will allow certain keys to function as left and right Control keys, Alternative keys, and/or Super keys. Modified scan codes at 606 for another operating system will allow certain keys to operate as appropriate inputs, such as for a macOS certain keys will function as left and right Command keys and/or Option keys.

Once the BIOS scan code has been modified so that the keyboard will generate scan codes that are appropriate for the selected operating system, then the manufacturing process continues at 607, such as by loading required drivers or requested applications.

In another embodiment, instead of using a generic keyboard at 604-606, the manufacturer may notice that the customer has selected a mismatched operating system and keyboard. For example, if a Windows OS is identified at 603 in the customer order along with a Linux keyboard, then at 604 the diagnostic tool sets the key scan codes so that the Linux keyboard operates for the Windows OS. For example, the key scan codes may be configured to reflect a keyboard having layout 200 (FIG. 2) or 300 (FIG. 3). That is, the modified BIOS keyboard scan codes allow certain keys on the Linux layout to function as a Windows key and/or a Copilot key.

The method outlined in process 600 provides increased customer satisfaction because there are no “dead” keys on the keyboard for the customer-selected operating system.

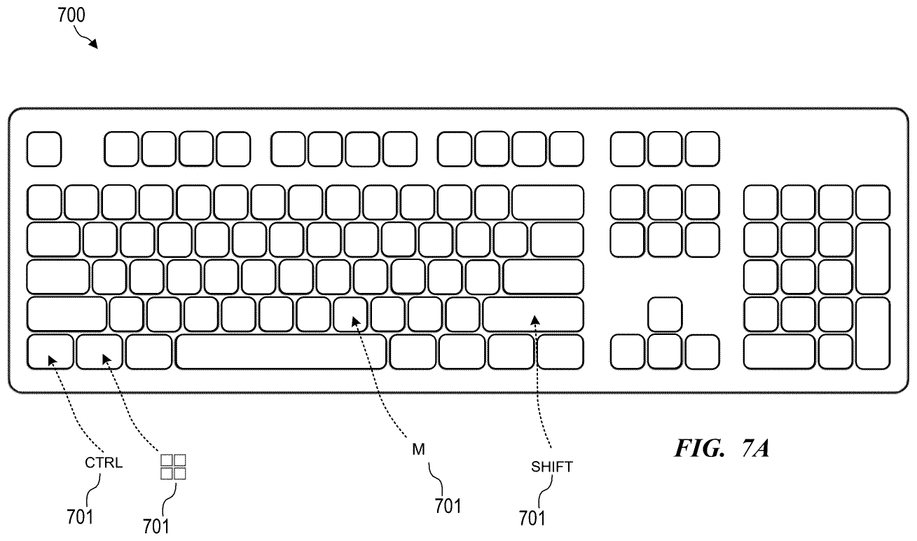

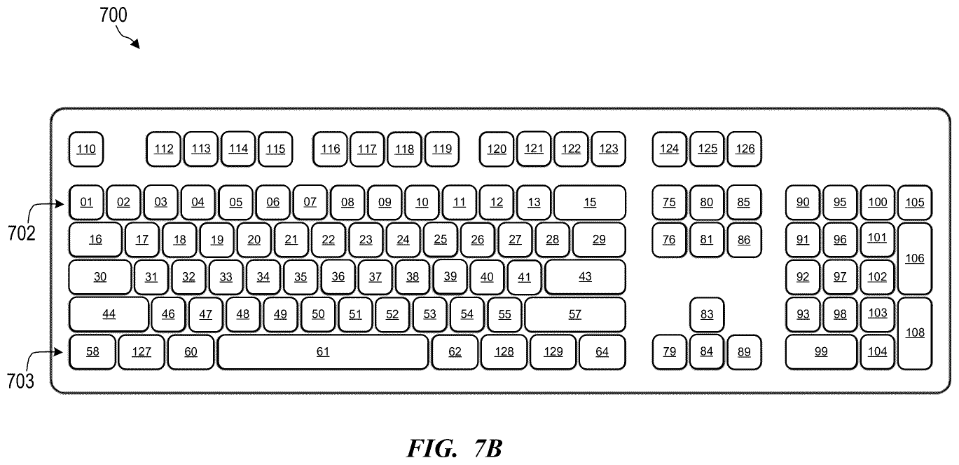

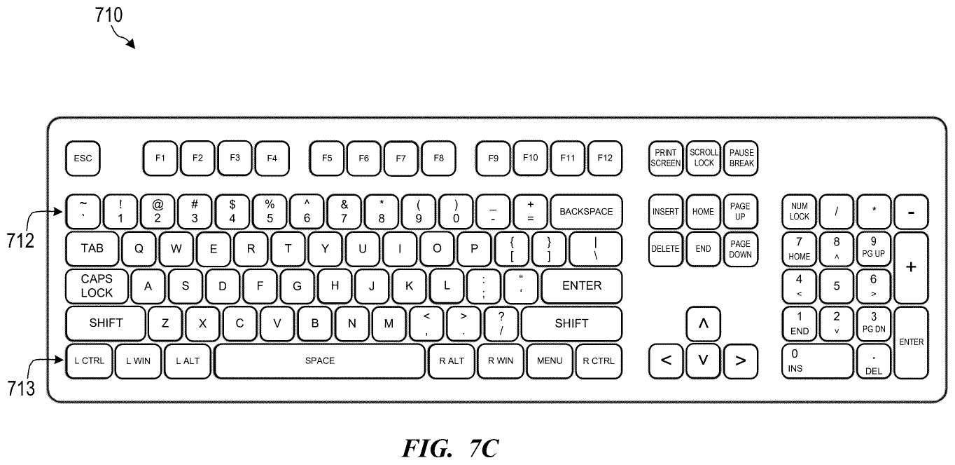

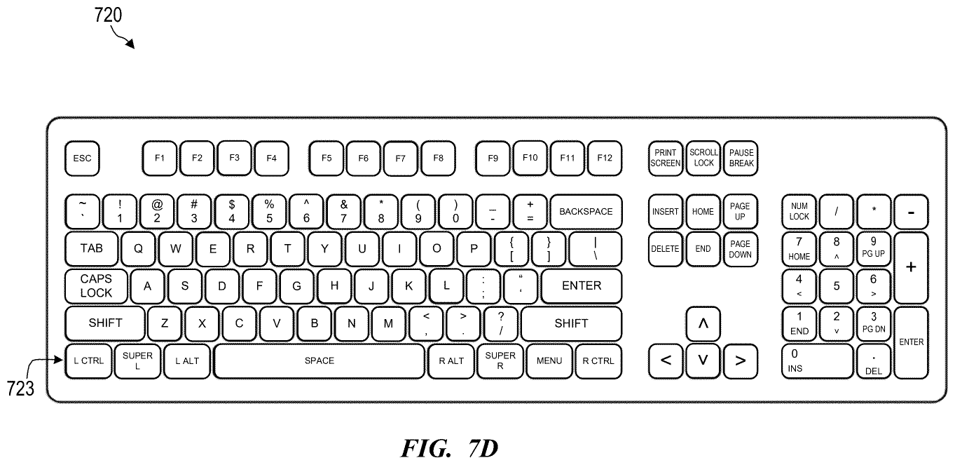

FIG. 7A illustrates an example of a generic keyboard 700 that can be paired with any operating system and/or keyboard layout during a manufacturing process. The generic keyboard 700 allows a vendor of a computer system (e.g., a system comprising an IHS with operating system loaded, a keyboard, monitors, pointing device/mouse, etc.) to assign each key a particular operation or function or a letter, number, or other character/punctuation mark as appropriate for the operating system loaded on the associated IHS. Once the keys are assigned, the vendor may apply a label 701 to each key so that users understand each key's assignment. The labels 701 may be applied as stickers or by printing, for example. A keycap or other small plastic cover is typically placed over the keyswitch for each key on the keyboard. Keycaps may be labeled to indicate the key's corresponding function or alphanumeric character.

The generic keyboard 700 is an extreme version in which the keys are unlabeled, which allows the vendor or system manufacturer to assign any role to each key. In other configurations, the generic keyboard 700 may have only certain keys that are blank or unassigned while the remainder of the keys are preassigned. For example, the alphabet, number, function keys, etc. may be labeled and expected to perform the labeled operation, but the bottom row on either side of the space bar may be unassigned and, therefore, easily adapted to various operating systems.

FIG. 7B illustrates the generic keyboard with each key numbered for reference. The numbers shown in FIG. 7B are not intended to reflect values assigned to each key but instead are used to designate each key. For example, key 43 is often assigned as the ENTER key and key 61 is often assigned as the SPACE BAR. However, a vendor may assign any operation or value to any key in one embodiment. Each key creates a unique scan code. The vendor can assign the scan codes to desired operations or values based upon the user/customer's desire and/or the operating system requirements. For example, a customer order may specify a desired operating system for an IHS and a desired keyboard configuration, and the vendor may assign the key scan codes for keyboard 700 as appropriate to meet the customer's needs.

In a typical keyboard layout, the top row (i.e., keys 110 and 112-123) are assigned the ESCAPE and FUNCTION F1-F12 operations. The next topmost row 702 (i.e., keys 01-13 and 15) are often assigned as the number keys (with punctuation available with SHIFT) and the BACKSPACE key. An example scan code assignment for the second topmost row of keys is shown in Table 1, which lists the scan code in hexadecimal format. In other configurations, the scan code may be in binary, decimal, or other format.

TABLE 1

| | | Character/Function |
|---|---|---|
| Key # | Scan Code | (keycap) |
| 01 | 0e | ′ ~ |
| 02 | 16 | 1 ! |
| 03 | 1e | 2 @ |
| 04 | 26 | 3 # |
| 05 | 25 | 4 $ |
| 06 | 2e | 5 % |
| 07 | 36 | 6 \hat{ } |
| 08 | 3d | 7 & |
| 09 | 3e | 8 * |
| 10 | 46 | 9 ( |
| 11 | 45 | 0 ) |
| 12 | 4e | - _{—} |
| 13 | 55 | = + |
| 15 | 66 | BACKSPACE |

FIG. 7C illustrates a keyboard 710 having keys in a top row 712 assigned as shown in Table 1.

Following a key press by a user, the IHS receives the associated scan code for that key. The BIOS assigns a default value to the scan codes, which is then used by the operating system and applications to determine how to handle each received scan code (i.e., which character or function to use for a key press). In embodiments disclosed herein, the vendor may assign any character or function to each key's scan code so that any combination of characters and functions can be arranged on the generic keyboard 700. That is, the vendor may reassign any of the characters and functions in the right column in Table 1 to meet operating system and/or user needs.

As noted in the discussion above, the bottom row keys 703 are often assigned different functions based upon the operating system loaded on the IHS. Table 2 lists example key and scan codes assignments for a Windows operating system. This set of scan code assignments corresponds to bottom row 713 in example keyboard layout 710 (FIG. 7C).

TABLE 2

| | | Character/Function |
|---|---|---|
| Key # | Scan Code | (keycap) |
| 58 | 11 | L CONTROL |
| | | (CTRL) |
| 127 | 8b | L WINDOWS |
| | | (Windows logo) |
| 60 | 19 | L ALTERNATE |
| | | (ALT) |
| 61 | 29 | SPACE |
| 62 | 39 | R ALTERNATE |
| | | (ALT) |
| 128 | 8c | R WINDOWS |
| | | (Windows logo) |
| 129 | 8d | MENU |
| 64 | 58 | R CONTROL |
| | | (CTRL) |

Alternatively, if the IHS is running a Linux operating system, the keys in bottom row 703 may be assigned a different group of functions that are better suited for Linux. For example, Table 3 illustrates a scan code assignment for bottom row 703 in a Linux operating system environment. This arrangement of functions is shown as bottom row 723 in the example Linux keyboard layout 720 shown in FIG. 7D.

TABLE 3

| | | Character/Function |
|---|---|---|
| Key # | Scan Code | (keycap) |
| 58 | 11 | L CONTROL |
| | | (CTRL) |
| 127 | 8b | L SUPER |
| 60 | 19 | L ALTERNATE |
| | | (ALT) |
| 61 | 29 | SPACE |
| 62 | 39 | R ALTERNATE |
| | | (ALT) |
| 128 | 8c | R SUPER |
| 129 | 8d | MENU |
| 64 | 58 | R CONTROL |
| | | (CTRL) |

The scan codes for keys in bottom row 703 may be assigned to any other function by the vendor to meet operating system and user requirements, needs, or desires. The scan code assignments may then be saved as default values for the IHS BIOS so that the same configuration is available to the user on each system boot.

While FIGS. 7A-D illustrate keyboard key assignments for a 94-key keyboard, it will be understood that any other keyboard configuration may use the methods disclosed herein to assign key functions and values. Additionally, it will be understood that while examples are discussed for assigning the scan codes for rows 702 and 703 (FIG. 7B), the scan codes for the remaining keys on the keyboard 700 may be assigned in a similar manner.

Tables 1-3 list example scan codes for certain keys. It will be understood that the listed keys may be assigned other scan codes in other embodiments. For example, various scan code sets may be available for different keyboard manufacturers and different keyboard configurations. Accordingly, any key may be assigned any scan code by a manufacturer and those assigned scan codes may be assigned default values by a system vendor to provide desired functions and character inputs to the IHS operating system. Additionally, in some keyboard and IHS configurations, the scan codes sent by a keyboard may be translated into a different scan code set by the IHS, such as by a keyboard interface. In such a configuration, the translated scan codes may be assigned default values for use by the BIOS.

In an example configuration, a method for assigning keyboard scan codes during manufacturing of an Information Handling System (IHS) comprises loading an operating system on the IHS; utilizing a diagnostic tool to read customer order data associated with the IHS; determining, by the diagnostic tool, appropriate keyboard scan code settings based on the customer order data and operating system requirements; and modifying default BIOS scan codes to align with the determined keyboard scan code settings. The modified default BIOS scan codes may cause a generic keyboard to provide specific keys required by the operating system.

The specific keys may be one or more of a Windows key and a Copilot key for a Windows operating system. The specific keys may be one or more of a right Control key, a Super key, and a Menu key for a Linux operating system. The specific keys may be one or more of a Command key and an Option key for a macOS operating system.

The modified BIOS default scan codes may cause a keyboard with a layout for a first operating system to operate as a keyboard with a layout for a second operating system.

The first operating system may be a Windows operating system and the second operating system may be a Linux operating system, and wherein the modified BIOS default scan codes cause a Copilot key to function as a right Control key.

A particular key on a keyboard may have a first function when used with a first operating system and have a second function with used with a second operating system. The modified BIOS scan codes may cause the particular key to provide the function associated with the operating system loaded on the IHS.

The method may further comprise applying a label to the particular key, wherein the label identifies the function associated with the operating system loaded on the IHS.

In another example configuration, a computer system comprises an Information Handling System (IHS) having at least one processor configured to execute an operating system and having a basic input/output system (BIOS) identifying default key scan codes; and a keyboard having a plurality of key, wherein each of the keys are configured to generate a unique scan code. The BIOS default key scan codes are configured during manufacture to match scan codes used by the operating system.

The computer system keyboard may be a generic keyboard, and wherein the BIOS default scan codes cause the generic keyboard to provide specific keys required by the operating system.

The specific keys on the keyboard may be one or more of a Windows key and a Copilot key for a Windows operating system. The specific keys on the keyboard may be one or more of a right Control key, a Super key, and a Menu key for a Linux operating system. The specific keys on the keyboard may be one or more of a Command key and an Option key for a macOS operating system.

The BIOS default scan codes may cause a keyboard with a layout for a first operating system to operate as a keyboard with a layout for a second operating system. The first operating system may be a Windows operating system and the second operating system may be a Linux operating system, and wherein the modified BIOS default scan codes cause a Copilot key to function as a right Control key.

A particular key on the keyboard may have a first function when used with a first operating system and a second function with used with a second operating system. The BIOS default scan codes may cause the particular key to provide the function associated with the operating system loaded on the IHS.

The computer system may further comprises a label applied to the particular key, wherein the label identifies the function associated with the operating system loaded on the IHS.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

What is claimed is:

1. A method for assigning keyboard scan codes during manufacturing of an Information Handling System (IHS), comprising:
loading an operating system on the IHS;
utilizing a diagnostic tool to read customer order data associated with the IHS;
determining, by the diagnostic tool, appropriate keyboard scan code settings based on the customer order data and operating system requirements; and
modifying default BIOS scan codes to align with the determined keyboard scan code settings.

2. The method of claim 1, wherein the modified default BIOS scan codes cause a generic keyboard to provide specific keys required by the operating system.

3. The method of claim 2, wherein the specific keys are one or more of a Windows key and a Copilot key for a Windows operating system.

4. The method of claim 2, wherein the specific keys are one or more of a right Control key, a Super key, and a Menu key for a Linux operating system.

5. The method of claim 2, wherein the specific keys are one or more of a Command key and an Option key for a macOS operating system.

6. The method of claim 1, wherein the modified BIOS default scan codes cause a keyboard with a layout for a first operating system to operate as a keyboard with a layout for a second operating system.

7. The method of claim 6, wherein the first operating system is a Windows operating system and the second operating system is a Linux operating system, and wherein the modified BIOS default scan codes cause a Copilot key to function as a right Control key.

8. The method of claim 1, wherein a particular key on a keyboard has a first function when used with a first operating system and has a second function with used with a second operating system; and
wherein the modified BIOS scan codes cause the particular key to provide the function associated with the operating system loaded on the IHS.

9. The method of claim 8, further comprising:
applying a label to the particular key, wherein the label identifies the function associated with the operating system loaded on the IHS.

10. A computer system, comprising:
an Information Handling System (IHS) having at least one processor configured to execute an operating system and having a basic input/output system (BIOS) identifying default key scan codes; and
a keyboard having a plurality of key, wherein each of the keys are configured to generate a unique scan code;
wherein the BIOS default key scan codes are configured during manufacture to match scan codes used by the operating system.

11. The computer system of claim 10, wherein the keyboard is a generic keyboard, and wherein the BIOS default scan codes cause the generic keyboard to provide specific keys required by the operating system.

12. The computer system of claim 11, wherein the specific keys are one or more of a Windows key and a Copilot key for a Windows operating system.

13. The computer system of claim 11, wherein the specific keys are one or more of a right Control key, a Super key, and a Menu key for a Linux operating system.

14. The computer system of claim 11, wherein the specific keys are one or more of a Command key and an Option key for a macOS operating system.

15. The computer system of claim 10, wherein the BIOS default scan codes cause a keyboard with a layout for a first operating system to operate as a keyboard with a layout for a second operating system.

16. The computer system of claim 15, wherein the first operating system is a Windows operating system and the second operating system is a Linux operating system, and wherein the modified BIOS default scan codes cause a Copilot key to function as a right Control key.

17. The computer system of claim 10, wherein a particular key on the keyboard has a first function when used with a first operating system and has a second function with used with a second operating system; and
wherein the BIOS default scan codes cause the particular key to provide the function associated with the operating system loaded on the IHS.

18. The computer system of claim 17, further comprising:
a label applied to the particular key, wherein the label identifies the function associated with the operating system loaded on the IHS.
